(19) United States
(12) Patent Application Publication
(10) Pub. No.: US 2014/0356618 A1
(43) Pub. Date: Dec. 4, 2014

(54) MULTILAYER FILM AND OPTICAL SHEET

(71) Applicant: FUJIFILM Corporation, Tokyo (JP)

(72) Inventors: Hidemasa HOSODA, Minami-ashigara-shi (JP); Kunihiko OHGA, Minami-ashigara-shi (JP); Tatsuya NOMURA, Minami-ashigara-shi (JP); Takashi KOBAYASHI, Minami-ashigara-shi (JP)

(73) Assignee: FUJIFILM Corporation, Tokyo (JP)

(21) Appl. No.: 14/459,660

(22) Filed: Aug. 14, 2014

Related U.S. Application Data
(63) Continuation of application No. PCT/JP2013/055165, filed on Feb. 27, 2013.

(30) Foreign Application Priority Data
Mar. 23, 2012 (JP) 2012-066711

(51) Int. Cl. C09J 133/00; C09J 123/02; G02B 5/02

(52) U.S. Cl. CPC C09J 133/00; G02B 5/02; C09J 123/02; C09J 2423/00; C09J 2433/00
USPC 428/336

(57) ABSTRACT

A prism sheet as an optical functional sheet is a multilayer sheet, and includes a prism layer as an optical functional layer containing an organic material and a multilayer film. The multilayer film includes a film base and a first adhesive layer provided on the film base. The prism layer is formed on the first adhesive layer in a subsequent process. The thickness of the first adhesive layer is at least 0.1 μm. The first adhesive layer contains at least 10 mass % of polyolefin.

### CROSS-REFERENCE TO RELATED APPLICATIONS

This application is a Continuation of PCT International Application No. PCT/JP2013/055165 filed on Feb. 27, 2013, which claims priority under 35 U.S.C §119(a) to Japanese Patent Application No. 2012-066711 filed Mar. 23, 2012. The above application is hereby expressly incorporated by reference, in its entirety, into the present application.

### BACKGROUND OF THE INVENTION

1. Field of the Invention

The present invention relates to a multilayer film and an optical sheet provided with an optical functional layer.

2. Description Related to the Prior Art

A display device such as a liquid crystal display or a plasma display uses an optical functional sheet made from polymer. Examples of the optical functional sheet include a prism sheet, an anti-reflection sheet, a light diffusion sheet, a hard coat sheet, an IR absorption sheet, an electromagnetic wave shielding sheet, a toning sheet, and an anti-glare sheet. The optical functional sheet is provided with a sheet-like optical functional layer made from an organic material and a film base for supporting the optical functional layer. For example, the prism sheet is provided with a sheet-like prism layer and a polyester film base for supporting the prism layer.

However, even in the case where the optical functional layer is directly formed on the polyester film base, the adhesive strength between the film base and the optical functional layer is often insufficient. In order to increase the adhesive strength between the optical functional layer and the film base, an adhesive layer is formed on the film base such that the film base adheres to the optical functional layer via the adhesive layer.

There have been proposed various kinds of adhesive layers for increasing the adhesive strength between a polyester film base and a layer formed on the polyester film base. For example, an adhesive layer consisting of a resin composition containing resin and particles is disclosed in Japanese Patent Laid-Open Publication No. 2006-187880. The resin for use in the adhesive layer is polyester, polyurethane, acrylic, or maleic acid-graft-modified polyolefin.

Incidentally, an optical functional layer which is made from a soft material and returns to its original shape after being deformed once has been recently developed. For example, conventionally, an elastic modulus of a prism layer of a prism sheet was at least 1,000 MPa, but recently, instead of the conventional prism layer, a prism layer having an elastic modulus of at most 200 MPa has been developed. The prism layer having such a low elastic modulus has the following merits in comparison with the conventional prism layer having a high elastic modulus. Upon being in contact with other components, the prism layer having such a low elastic modulus leaves less scratches on the other components. Additionally, a protection film to be formed on a prism layer for the purpose of ensuring enough strength for transportation and storage becomes unnecessary in the case of using the prism layer having such a low elastic modulus. It is highly possible that such an optical functional layer which has a low elastic modulus and returns to its original shape after being deformed is applied as not only the prism layer but also other optical functional layers such as a micro lens layer.

However, the prism layer, which has a low elastic modulus and returns to its original shape after being deformed as described above, has extremely low adhesive strength relative to the polyester film base, and even if the adhesive layer disclosed in Japanese Patent Laid-Open Publication No. 2006-187880 is provided, the adhesive strength relative to the polyester film base is insufficient. A cross-cut peeling test is commonly used as an adhesive strength evaluation method. Upon being cross-cut, the prism layer deforms to a large extent or returns to its original shape. The adhesive layer used conventionally cannot keep the adhesion between the prism layer and the film base upon being cross-cut.

### SUMMARY OF THE INVENTION

An object of the present invention is to provide a multilayer film in which adhesive strength between a film base and an optical functional layer having a low elastic modulus to return to its original shape after being deformed is increased, and an optical sheet.

A multilayer film of the present invention includes a film base and an adhesive layer. The film base contains polyester. The adhesive layer is provided on one of surfaces of the film base and has a thickness of at least 0.1 μm. The adhesive layer is used to attach the film base to an optical functional layer containing an organic material. The adhesive layer contains at least 10 mass % of polyolefin.

The adhesive layer preferably has an elastic modulus of at most 500 MPa.

It is preferable that the adhesive layer contains a cross-linking agent. The cross-linking agent is preferably any one of an oxazoline compound, a carbodiimide compound, epoxy, isocyanate, and melamine.

The adhesive layer preferably contains acrylic resin. A mass ratio of the acrylic resin to the polyolefin is preferably in a range of not less than 5% to not more than 700%.

An optical sheet of the present invention includes an optical functional layer, a film base, and an adhesive layer. The optical functional layer deflects incident light so as to collect or diffuse the incident light, and contains an organic material. The film base contains polyester. The adhesive layer is provided between the film base and the optical functional layer and has a thickness of at least 0.1 μm. The adhesive layer is used to attach the film base to the optical functional layer, and contains at least 10 mass % of polyolefin.

It is preferable that the adhesive layer has an elastic modulus of at most 500 MPa. The adhesive layer preferably contains a cross-linking agent. The cross-linking agent is preferably any one of an oxazoline compound, a carbodiimide compound, epoxy, isocyanate, and melamine.

According to the present invention, the adhesive strength between the film base and the optical functional layer having a low elastic modulus to return to its original shape after being deformed is increased.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic side view of a liquid crystal display device;

FIG. 2 is a cross-sectional view of a prism sheet including a multilayer film;

FIG. 3 is an explanatory view illustrating change in shape of the multilayer film;

FIG. 4 is a cross-sectional view of a prism sheet including a multilayer film; and

FIG. 5 is an explanatory view illustrating change in shape of the prism sheet.

### DESCRIPTION OF THE PREFERRED EMBODIMENTS

A multilayer film of the present invention, which is provided with an optical functional layer in a subsequent process, is used as an optical sheet in a liquid crystal display device. The optical functional layer deflects incident light so as to collect or diffuse the incident light. Examples of the optical functional layer includes a prism layer, a micro lens layer, and the like. Further, in some cases, the multilayer film of the present invention is provided with a hard coat for giving scratch resistance in a subsequent process.

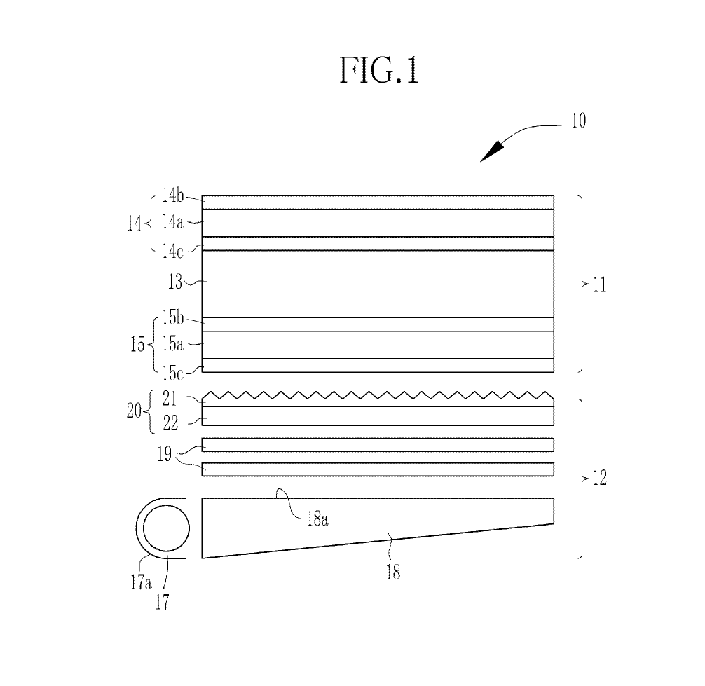

A liquid crystal display device provided with the multilayer film of the present invention is schematically shown in FIG. 1. The liquid crystal display device shown in FIG. 1 is just one example, and an aspect of using the multilayer film of the present invention is not limited thereto. In this example, the liquid crystal display device is provided with a prism sheet according to a general aspect, and the prism sheet includes the multilayer film. A liquid crystal display device 10 includes a liquid crystal panel 11 and a light source unit 12. The liquid crystal panel 11 consists of a liquid crystal cell 13 and two polarizing filters 14 and 15. The liquid crystal cell 13 is made up of liquid crystal enclosed between transparent glass substrates. A transparent electrode is formed on an inner face of each of the glass substrates. By applying voltage between the transparent electrodes, a polarizing state of the light passing through the liquid crystal cell 13 is changed.

The polarizing filter 14 consists of a polarizing film 14a and a pair of protection films 14b and 14c affixed to respective surfaces of the polarizing film 14a. The polarizing filters 14 and 15 have the same structure. Namely, the polarizing filter 15 consists of a polarizing film 15a and protection films 15b and 15c. The polarizing filters 14 and 15 are placed in a crossed Nicols arrangement. The liquid crystal cell 13 is disposed between the polarizing filters 14 and 15.

The light source unit 12 illuminates the liquid crystal panel 11 from the back of the liquid crystal panel 11. The light source unit 12 is composed of a light source lamp 17, a light guide plate 18, a diffusion sheet 19, and the prism sheet 20, for example. The light source lamp 17 is a rod-like cold cathode fluorescent lamp (CCFL) or a light emitting device (LED), for example. The light source unit 12 shown in FIG. 1 adopts an edge light method. The light source lamp 17 is placed along an edge of the light guide plate 18 having a wedge-shaped cross section. The illumination light emitted from light source lamp 17 is directly incident on an end of the light guide plate 18 or reflected by a reflector 17a, so as to enter the light guide plate 18. The incident illumination light is reflected from the inside of the light guide plate 18, and is exited from an exit surface 18a of the light guide plate 18. The exit surface 18a has substantially the same size as the liquid crystal panel 11.

In this example, the light source lamp 17 is placed along the edge constituting one side of the rectangular light guide plate 18, when the light guide plate 18 is viewed from a vertical direction of the exit surface 18a thereof. However, the light source lamp 17 may be placed along two or three sides of the light guide plate 18, or placed along all four sides of the light guide plate 18. Further, as described above, the light guide plate 18 has the wedge-shaped cross section, and is placed such that the thickness of the light guide plate 18 is the largest at the side near the light source lamp 17 and is gradually decreased as the distance from the light source lamp 17 is increased. However, instead of the light guide plate 18 described above, a light guide plate having a uniform thickness may be used. Further, a light diffusion function may be imparted to a surface of the light guide plate 18 by applying a dot pattern using screen printing or the like. Alternatively, a material having a scattering effect may be mixed into the light guide plate 18 so as to achieve the light diffusion function. The light guide plate 18 provided with such a light diffusion function emits light more uniformly. The light guide plate 18 is preferably made from a material which absorbs visible light as little as possible. Such a material is acrylic resin or polycarbonate, for example.

The diffusion sheet 19 is used for illuminating the whole surface of the liquid crystal panel 11 uniformly. The diffusion sheet 19 is disposed in proximity to the exit surface 18a. The diffusion sheet 19 scatters and diffuses the illumination light incident from the exit surface 18a, while transmitting the illumination light. Examples of the diffusion sheet 19 include a transparent sheet on which beads-like light diffusion materials are dispersed, a sheet in which the light diffusion materials are dispersed, and a so-called micro lens obtained by curing and molding UV curable resin with use of plural lens-shaped molds.

Concrete examples of a method for illuminating the whole surface of the liquid crystal panel 11 uniformly are as follows. In the case where the light guide plate 18 is applied with a dot pattern using screen printing or the like, it is possible to blur the dot pattern. In the case where a plurality of LEDs are used as the light source lamp 17, it is possible to eliminate brightness unevenness caused by gaps between the adjacent LEDs. Further, it is also possible to conceal minute scratches or the like generated during a mounting process so as to improve the production yield. Additionally, in order to prevent generation of scratches and occurrence of interference unevenness on the surface of the diffusion sheet 19 in contact with the light guide plate 18, a coating layer containing various matting agents may be disposed on the surface of the diffusion sheet 19 in contact with the light guide plate 18, or the surface of the diffusion sheet 19 in contact with the light guide plate 18 may be roughed.

The prism sheet 20 is disposed between the liquid crystal panel 11 and the diffusion sheet 19, and improves the front brightness. In other words, the prism sheet 20 controls distribution of the illumination light so as to increase the amount of the illumination light applied in a normal direction to the liquid crystal panel 11. The size of the prism sheet 20 is substantially the same as the back surface of the liquid crystal panel 11. The prism sheet 20 includes a prism layer 21 and a multilayer film 22. The multilayer film 22 supports the prism layer 21. In many cases, the prism layer 21 is placed at the side near the liquid crystal panel 11 and the multilayer film 22 is placed at the side near the diffusion sheet 19 in the prism sheet 20. The illumination light diffused by the diffusion sheet 19 is incident on the multilayer film 22 of the prism sheet 20, and the illumination light emitted from the prism layer 21 is incident on the liquid crystal panel 11.

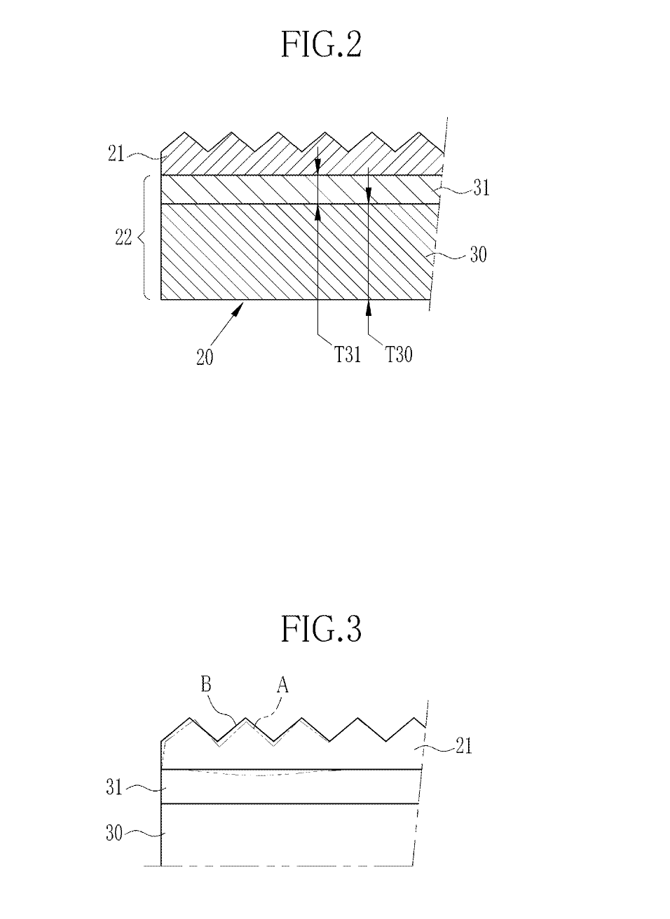

The prism sheet 20 is obtained by providing the multilayer film 22 with the prism layer 21 as described above. As shown in FIGS. 2 and 3, a plurality of prisms each having a triangular cross section are arranged on one of surfaces of the prism layer 21, and the light incident from the other surface of the prism layer 21 is emitted from the prisms.

In the light source unit 12, the prism layer 21 is located in the most downstream side in an advancing direction of the illumination light. Therefore, when the light source unit 12 is viewed at a slanted angle from the prism layer 21, color unevenness called as rainbow unevenness occurs in some cases. The color unevenness is caused by prism spectrum. The prism spectrum occurs in accordance with wavelength dispersibility of the refractive index of the polymer constituting the prism layer 21. For the purpose of preventing such color unevenness, it is generally performed to dispose another diffusion sheet 19 on the prism layer in the light source unit 12, impart scattering function to at least part of the protection film 14b of the polarizing filter 14 and the protection film 15b of the polarizing filter 15 in the liquid crystal panel 11, impart scattering function to the inside or the surface of the prism layer 21, or make each of the prisms into a special shape. Incidentally, from the view point of cost reduction, a light scattering layer with haze in the order of 5% to 50%, preferably 10% to 50% may be disposed on the surface of the prism sheet 20 which is opposite to the prism layer 21, namely on the surface of the multilayer film 22, so as to prevent color unevenness.

The prism layer 21 may have an elastic modulus in a range of note less than 1,000 MPa to not more than 3,000 MPa, that is, the prism layer 21 may be hard. However, in this example, the prism layer 21 is made from a soft material having an elastic modulus in a range of not less than 1 MPa to less than 1,000 MPa so as to be elastically deformable. The elastic modulus of the prism layer 21 is more preferably in a range of not less than 10 MPa to not more than 200 MPa. The prism layer 21 having a high elastic modulus of at least 1,000 MPa does not deform enough to be visually confirmed upon being applied with external force. Otherwise, even if the prism layer 21 deforms, the prism layer 21 does not return to its original shape. In contrast, the prism layer 21 having a low elastic modulus of less than 1,000 MPa deforms into a state shown by the double-dashed line A in FIG. 3 upon being applied with external force. However, when the application of the external force is cancelled, the shape of the prism layer 21 is restored, that is, the prism layer 21 returns to its original shape shown by the solid line B in FIG. 3.

The prism layer 21 consists of organic polymer. However, the prism layer 21 may contain inorganic or organic materials and additive agents as long as the prism layer 21 keeps the behavior of the prism. The organic polymer backbone may contain inorganic atoms. The organic polymer contained in the prism layer 21 is obtained by applying active energy rays to a compound having a functional group which is cured by cross-linking reaction or polymerization reaction upon being applied with active energy rays. The active energy rays may be any one of electromagnetic waves such as visible light rays, ultraviolet rays, and X rays, and particle beams such as α rays, as long as they have energy enough to cause the reaction described above. However, the active energy rays are generally ultraviolet rays. The polymer obtained by application of ultraviolet rays is referred to as UV curable resin in this specification.

The prism layer 21 is formed from a coating liquid as described later. The present invention is particularly effective in the case where the coating liquid for forming the prism layer 21 does not require a drying process after the application of the coating liquid, namely, in the case where the coating liquid is a solvent-free coating liquid using reactive diluent, or in the case where the coating liquid is a UV-curable acrylic coating liquid.

The solvent-free UV-curable acrylic coating liquid preferably contains at least any one of a compound expressed by a general formula (1) in which an average added mol number (x+y) is at least 5 and a compound expressed by a general formula (2) in which “z” is at least 2. The total amount of the compound expressed by the general formula (1) and the compound expressed by the general formula (2) is preferably at least 20 mass % with respect to the mass of the coating liquid. It is preferable that the average added mol number (x+y) is at most 30 in view of solubility. In the case where the average added mol number (x+y) is more than 30, the brightness is lowered due to decrease in the refractive index, or coating performance of the coating liquid becomes poor due to low solubility thereof in some cases. Note that the average added mol number (x+y) is preferably in a range of not less than 6 to not more than 28.

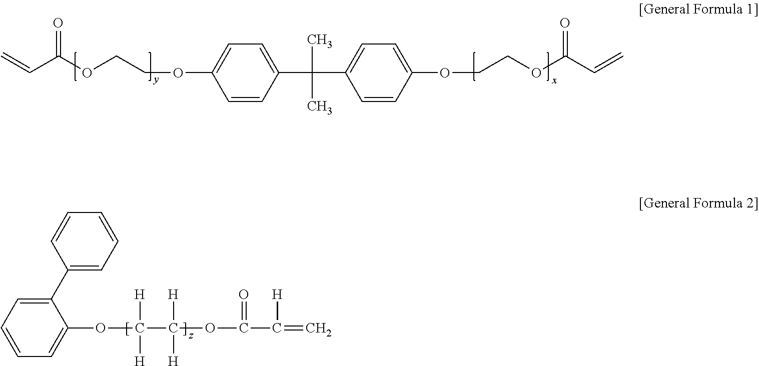

The multilayer film 22 includes at least a thin film base 30 and a first adhesive layer 31 disposed so as to be in close contact with one of surfaces of the film base 30.

The film base 30 is used to support the optical functional layer. For example, in the case where the film base 30 is supposed to be for use in the prism sheet 20, the film base 30 is used to support the prism layer 21. The film base 30 is made from polyester, and may include an additive agent such as plasticizer. The polyester is not particularly limited, and may be, for example, polyethylene terephthalate, polyethylene naphthalate, polybutylene terephthalate, or polybutylene naphthalate. Of those, the polyethylene terephthalate is especially preferable in view of cost and mechanical strength.

It is preferable that the film base 30 is subjected to stretching so as to improve its mechanical strength required for use in supporting the optical functional layer. The film base 30 subjected to biaxial stretching is especially preferable. A stretch or draw ratio is not particularly limited, but the stretch ratio in a range of not less than 1.5 times to not more than 7 times is preferable. When the stretch ratio is less than 1.5 times, the mechanical strength becomes insufficient in some cases. On the other hand, when the stretch ratio exceeds 7 times, it becomes difficult to keep the film thickness uniform. More preferably, the stretch ratio is in a range of not less than 2 times to not more than 5 times. A film stretched biaxially at the stretch ratio in a range of not less than 2 times to not more than 5 times in each of two directions orthogonal to each other in the film surface is especially preferable.

A thickness T30 of the film base 30 is uniform in a range of not less than 30 μm to not more than 500 μm, and more preferably in a range of not less than 50 μm to not more than 300 μm. It is not preferable when the thickness T30 of the film base 30 is less than 30 μm, because the film base 30 becomes too soft to handle. On the other hand, the film base 30 which has the thickness T30 exceeding 500 μm hinders downsizing and weight reduction of the display device, and thus resulting in cost increase.

The first adhesive layer 31 is used to attach the film base 30 to the prism layer 21. An elastic modulus of the first adhesive layer 31 is preferably at most 500 MPa, namely not more than 500 MPa. The elastic modulus of the first adhesive layer 31 is more preferably in a range of not less than 10 MPa to not more than 500 MPa, and furthermore preferably in a range of not less than 50 MPa to not more than 500 MPa. The first adhesive layer 31 has an extremely low elastic modulus as described above while the conventional adhesive layer has an elastic modulus of at least 600 MPa. Thereby, upon elastic deformation of the prism layer 21, the first adhesive layer 31 is stretched or contracted at an extremely micro level so as to follow the change in shape of the prism layer 21. For example, when the prism layer 21 deforms into a state shown by the double-dashed line A in FIG. 3 in a direction of being pressed against the film base 30, the first adhesive layer 31 contracts such that a thickness T31 thereof is decreased. Further, when the deformed prism layer 21 returns to its original shape shown by the solid line B in FIG. 3, the first adhesive layer 31 returns to its original shape and have an original thickness again. As described above, the first adhesive layer 31 has the property of changing its thickness and returning to its original shape. Since the first adhesive layer 31 has stretching properties, even if the shape of the prism layer 21 changes, the prism layer 21 remains to be attached to the film base 30 without being peeled from the film base 30. Note that, the state in which the prism layer 21 is peeled from the film base 30 means at least any one of the following states: “the state in which the prism layer 21 is peeled from the first adhesive layer 31”, “the state in which the inside of the first adhesive layer 31 is broken”, and “the state in which the first adhesive layer 31 is peeled from the film base 30”.

The fracture elongation of the first adhesive layer 31 is in a range of not less than 10% to not more than 300%, while the fracture elongation of the conventional adhesive layer is less than 5%. Accordingly, the first adhesive layer 31 is surely stretched to a large extent without being broken, when the prism layer 21 elastically deforms.

The first adhesive layer 31 contains a polymer component. The first adhesive layer 31 contains at least 10 mass % of polyolefin. When the total mass of the first adhesive layer 31 excluding the mass of the additive agent which occupies at most 5% of the total mass of the first adhesive layer 31 is assumed as 100, 10 mass % means that the mass ratio is at least 10, namely not less than 10. Since the first adhesive layer 31 contains at least 10 mass % of polyolefin, the first adhesive layer 31 comes to have the elastic modulus described above. The first adhesive layer 31 preferably contains polyolefin in a range of not less than 10 mass % to not more than 90 mass %, and more preferably in a range of note less than 20 mass % to not more than 80 mass %. Polyolefin is described in detail later.

It is generally known that the adhesive strength between polyolefin and polyester is low, and therefore polyolefin has not been used conventionally as a principal component in the adhesive layer for attaching the film base 30 made from polyester and the optical functional layer. Further, polyolefin can be contained in the adhesive layer only when polyolefin is contained in the film base 30 or the optical functional layer. However, according to the present invention, polyolefin is used as a principal component in the adhesive layer for attaching the film base 30 made from polyester and the optical functional layer regardless of whether or not the optical functional layer contains polyolefin. In order to prevent separation of the prism layer 21 from the film base 30 even while polyolefin is used as the principal component in the adhesive layer, the thickness T31 of the first adhesive layer 31 is set to at least 0.1 μm, namely not less than 0.1 μm. In the case where the thickness T31 of the first adhesive layer 31 is less than 0.1 μm, the prism layer 21 is easily peeled from the film base 30, and the prism layer 21 having a low elastic modulus is especially easily peeled from the film base 30. Further, in the case where the first adhesive layer 31 has the thickness T31 described above, the stress applied to the prism layer 21 as load by the cross-cut or the like in the cross-cut peeling test is relaxed in the first adhesive layer 31. The thickness T31 of the first adhesive layer 31 is preferably in a range of more than 0.1 μm to not more than 3.0 μm, more preferably in a range of more than 0.10 μm to not more than 2.0 μm, and furthermore preferably in a range of not less than 0.2 μm to not more than 1.5 μm. The thickness T31 of the first adhesive layer 31 is preferably uniform.

Additionally, resin which is hard to deteriorate under high temperature and high humidity is used, and thereby the elastic modulus and the fracture elongation describe above can be maintained even after the resin is exposed to high temperature and high humidity for a long time (for example, under the drying condition at a temperature of 85° C., or under the condition at a temperature of 65° C. and a relative humidity of 95% RH, for 100 to 500 hours), which is a highly-regarded condition than ever before. Polyolefin is resin which is hard to deteriorate under high temperature and high humidity, and therefore the first adhesive layer 31 using polyolefin can keep the elastic modulus and the fracture elongation described above even when being exposed to high temperature and high humidity for a long time.

The first adhesive layer 31 preferably contains a cross-linking agent. The cross-linking agent is used to further increase the adhesive strength between the prism layer 21 and the film base 30. The cross-linking agent may be anything as long as it causes the cross-linking reaction for forming the first adhesive layer 31, and need not to remain in the formed first adhesive layer 31. Namely, in the obtained multilayer film 22, the cross-linking agent may be incorporated as a part of the cross-linked structure containing cross-linked other molecules, namely, the cross-linking agent may have already finished the reaction and operation as the cross-linking agent. The cross-linking agent increase cross-linked points between and among molecules in the first adhesive layer 31. Accordingly, the first adhesive layer 31 more surely returns to its original shape, and the adhesive strength of the first adhesive layer 31 to the prism layer 21 and the film base 30 is further increased.

Preferable examples of the cross-linking agent to be contained in the first adhesive layer 31 include an oxazoline compound, a carbodiimide compound, epoxy, isocyanate, and melamine (C₃N₆H₆). These cross-linking agents may be contained in combination in the first adhesive layer 31. Particularly preferable example of the cross-linking agent is the carbodiimide compound. The details of the oxazoline compound, the carbodiimide compound, epoxy, and isocyanate are described later.

The first adhesive layer 31 preferably contains acrylic resin. The acrylic resin is used in combination with polyolefin so as to increase the fracture elongation of the first adhesive layer 31. The mass ratio of the acrylic resin to the polyolefin is preferably in a range of not less than 0% to not more than 700%, more preferably in a range of not less than 5% to not more than 700%, and furthermore preferably in a range of not less than 30% to not more than 300%. Note that, in this specification, “resin” does not mean a blend material secreted by plants, and it means polymer.

The details of the respective compounds constituting the first adhesive layer 31 are hereinafter described.

<Polyolefin>

The polyolefin may be polymer or copolymer obtained by polymerizing alkene including ethylene, butylene, and propylene, and collectively referred to as polyolefin polymer hereinbelow. The preferable polyolefin polymer is any one of the followings:
Copolymer of: ethylene or polypropylene; and acrylic monomer or methacrylic monomer.
Copolymer of: ethylene or polypropylene; and carboxylic acid (including anhydride).
Copolymer of: ethylene or polypropylene; acrylic monomer or methacrylic monomer; and carboxylic acid (including anhydride).

Preferable examples of the acrylic monomer or the methacrylic monomer for constituting the polyolefin polymer include methyl methacrylate, ethyl acrylate, butyl acrylate, and 2-hydroxyethyl acrylate.

Preferable examples of the carboxylic acid for constituting the polyolefin polymer include acrylic acid, methacrylic acid, itaconic acid, maleic acid, and maleic anhydride, and they may be used singly or in combination.

The ratio of ethylene or polypropylene to the polyolefin polymer is preferably in a range of 80 mol % to 98 mol %, and more preferably in a range of 85 mol % to 95 mol %, in total. The ratio of acrylic monomer or methacrylic monomer to the polyolefin polymer is preferably in a range of 0 mol % to 20 mol %, and more preferably in a range of 3 mol % to 10 mol %, in total. The ratio of carboxylic acid to the polyolefin polymer is preferably in a range of 0 mol % to 15 mol %, and more preferably in a range of 1 mol % to 10 mol %, in total. The monomer composition within the range described above achieves preferable adhesion and durability at the same time.

The molecular weight of the polyolefin polymer is preferably on the order of 2,000 to 200,000. The polyolefin polymer may have a linear structure or a branched structure. The polyolefin polymer is preferably dispersed in water (namely, in the form of so-called latex). As the method for dispersing the polyolefin polymer in water, emulsification or emulsification dispersion is performed, and the former is preferable. Specific methods are described in, for example, Japanese Patent No. 3699935.

The polyolefin polymer in the form of latex of polymer being dispersed in water preferably has a hydrophilic functional group such as carboxyl group and hydroxyl group. Further, the polyolefin polymer in the form of latex may contain a surface active agent (e.g., nonionic or anionic surface active agent) and an emulsion stabilizer such as polymer (e.g., polyvinyl alcohol) in order to increase stability. Additionally, as necessary, publicly-known compounds including a pH adjusting agent (e.g., ammonia, triethylamine, and sodium hydrogen carbonate), a preservative (e.g., 1,3,5-hexahydro-(2-hydroxyethyl)-s-triazine, and 2-(4-thiazolyl) benzimidazole), thickeners (e.g., sodium polyacrylate, and methyl cellulose), and a film-forming agent (e.g., butylcarbitolacetate) may be added as latex additive agents.

The polyolefin polymer in the form of latex to be used in the present invention is commercially available. As a commercialized product, there are, for example, BONDINE HX-8210, HX-8290, TL-8030, LX-4110 available from Sumitomo Chemical Co., Ltd., and ARROWBASE SA-1200, SB-1010, SE-1013N, SE1200 available from UNITIKA LTD.

<Oxazoline Compound>

Oxazoline compound is a compound having an oxazoline group represented by a general formula (3).

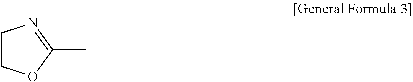

Examples of the oxazoline compound include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, and 2-isopropenyl-5-methyl-2-oxazoline. The oxazoline compounds may be used in combination. For example, EPOCROS K-2020E, EPOCROS K-2010E, EPOCROS K-2030E, EPOCROS WS-300, EPOCROS WS-500, or EPOCROS WS-700 available from NIPPON SHOKUBAI CO., LTD. can be used as the commercially available oxazoline compounds.

The additional amount of the oxazoline compound relative to the polymer component is preferably in a range of not less than 5 mass % to not more than 80 mass %, and more preferably in a range of not less than 10 mass % to not more than 40 mass %. By adding the oxazoline compound in the above range, it is possible to maintain the high adhesive strength to the film base 30 even under the high-temperature condition or under the high-temperature and high-humidity condition for a long time. On the other hand, when the additional amount of the oxazoline compound is less than 5 mass %, the adhesive strength to the film base 30 is decreased with time under the high-temperature condition or under the high-temperature and high-humidity condition in some cases. In contrast, when the additional amount of the oxazoline compound exceeds 80 mass %, the stability of the coating liquid is poor in some cases.

<Carbodiimide Compound>

The carbodiimide compound is a compound having a functional group represented by —N═C═N—. Generally, polycarbodiimide is synthesized by condensation reaction of organic diisocyanate. An organic group of the organic diisocyanate to be used for the synthesis is not particularly limited. One of aromatic system and aliphatic system, or a mixture of them may be used. In view of reactivity, the aliphatic system is particularly preferable. For synthetic raw materials, organic isocyanate, organic diisocyanate, organic triisocyanate, or the like is used.

Additional amount of the carbodiimide compound relative to the polymer component is preferably in a range of not less than 5 mass % to not more than 80 mass %, and more preferably in a range of not less than 20 mass % to not more than 75 mass %. By adding the carbodiimide compound in the above range, the adhesive strength to the film base 30 is further increased. On the other hand, When the additional amount of the carbodiimide compound exceeds 80 mass %, too much cost is incurred, although it causes no particular negative effect in view of the adhesive strength to the film base 30.

<Epoxy>

Epoxy is a compound having an epoxy group in the molecule, or a resultant compound of reaction of an epoxy group. Examples of the compound having the epoxy group in the molecule include condensates of epichlorohydrin with a hydroxyl group of ethylene glycol, polyethylene glycol, glycerol, polyglycerol, bisphenol A, etc., or an amino group. Specific examples of the compound include a polyepoxy compound, a diepoxy compound, a monoepoxy compound, and a glycidyl amine compound. Examples of the polyepoxy compound include sorbitol, polyglycidyl ether, polyglycerol polyglycidyl ether, pentaerythritol polyglycidyl ether, diglycerol polyglycidyl ether, triglycidyl tris(2-hydroxyethyl)isocyanate, glycerol polyglycidyl ether, and trimethylolpropane polyglycidyl ether. Examples of the diepoxy compound include neopentyl glycol diglycidyl ether, 1,6-hexanediol diglycidyl ether, resorcin diglycidyl ether, ethylene glycol diglycidyl ether, polyethylene glycol diglycidyl ether, propylene glycol diglycidyl ether, polypropylene glycol diglycidyl ether, and polytetramethylene glycol diglycidyl ether. Examples of the monoepoxy compound include allyl glycidyl ether, 2-ethylhexyl glycidyl ether, and phenyl glycidyl ether. Examples of the glycidyl amine compound include N,N,N′,N′-tetraglycidyl-m-xylylenediamine, and 1,3-bis(N,N-diglycidylamino) cyclohexane. Specific examples of the water-soluble monomer having the epoxy group include “Denacol-614B” (sorbitol polyglycidyl ether, weight per epoxy equivalent of 173, manufactured by Nagase ChemteX Corporation), “Denacol-EX-313” (glycerol polyglycidyl ether, weight per epoxy equivalent of 141, manufactured by Nagase ChemteX Corporation), “Denacol-EX-512” (polyglycerol polyglycidyl ether, weight per epoxy equivalent of 168, manufactured by Nagase ChemteX Corporation), and “Denacol-EX-830” (polyethylene glycol diglycidyl ether, weight per epoxy equivalent of 268, manufactured by Nagase ChemteX Corporation).

<Isocyanate>

Isocyanate is a compound having a partial structure of —N═C═O. Examples of the organic isocyanate include aromatic isocyanate, aliphatic isocyanate, and a mixture of them. To be more specific, 4,4′-diphenyl methane diisocyanate, 4,4-diphenyl dimethyl methane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethyl hexamethylene diisocyanate, 4,4′-dicyclohexyl methane diisocyanate, 1,3-phenylene diisocyanate, or the like is used. As organic monoisocyanate, isophorone isocyanate, phenyl isocyanate, cyclohexyl isocyanate, butyl isocyanate, naphthyl isocyanate, or the like is used. Examples of the carbodiimide compound includes CARBODILITE V-02-L2, CARBODILITE V-02, CARBODILITE V-04, CARBODILITE V-06, CARBODILITE E-01, CARBODILITE E-02, CARBODILITE E-03A, and CARBODILITE E-04 available from Nisshinbo Chemical Inc.

<Acrylic Resin>

The acrylic resin is in the form of a polymer obtained from a polymerizable monomer having a carbon-to-carbon double bond such as, typically, an acrylic monomer and a methacrylic monomer. The polymer may be either a homopolymer or a copolymer. The acrylic resin may also be in the form of a copolymer of such a polymer with the other polymer (such as, for example, polyester and polyurethane). Examples of the copolymer include a block copolymer and a graft copolymer. In addition, the acrylic resin may also be in the form of a polymer obtained by polymerizing the polymerizable monomer having a carbon-to-carbon double bond in a polyester solution or a polyester dispersion (which may also be in the form of a mixture of the polymers). Similarly, the acrylic resin may also be in the form of a polymer obtained by polymerizing the polymerizable monomer having a carbon-to-carbon double bond in a polyurethane solution or a polyurethane dispersion (which may also be in the form of a mixture of the polymers). Similarly, the acrylic resin may also be in the form of a polymer obtained by polymerizing the polymerizable monomer having a carbon-to-carbon double bond in the other polymer solution or the other polymer dispersion (which may also be in the form of a mixture of the polymers). In addition, in order to further improve the adhesion, a hydroxyl group or an amino group may be incorporated into the acrylic resin. The above polymerizable monomer having a carbon-to-carbon double bond is not particularly limited. Examples of the typical compound as the polymerizable monomer include various carboxyl group-containing monomers such as acrylic acid, methacrylic acid, crotonic acid, itaconic acid, fumaric acid, maleic acid and citraconic acid, and salts thereof; various hydroxyl group-containing monomers such as 2-hydroxyethyl (meth)acrylate, 2-hydroxypropyl (meth)acrylate, 4-hydroxybutyl (meth)acrylate, monobutylhydroxyl fumarate, and monobutylhydroxyl itaconate; various (meth)acrylic acid esters such as methyl (meth)acrylate, ethyl (meth)acrylate, propyl (meth)acrylate, butyl (meth)acrylate, and lauryl (meth)acrylate; various nitrogen-containing compounds such as (meth)acrylamide, diacetone acrylamide, N-methylol acrylamide, and (meth)acrylonitrile; styrene, various styrene derivatives such as α-methyl styrene, divinyl benzene, and vinyl toluene; various vinyl esters such as vinyl propionate; various silicon-containing polymerizable monomers such as γ-methacryloxypropyl trimethoxysilane, and vinyl trimethoxysilane; phosphorus-containing vinyl-based monomers; various halogenated vinyl-based monomers such as vinyl chloride and vinylidene chloride; and various conjugated dienes such as butadiene. As a commercially available acrylic acid ester copolymer, JURYMER ET-410 (manufactured by TOAGOSEI CO., LTD.) is preferably used.

The multilayer film 22 is produced by the following method. The film base 30 is formed by extruding melted polymer. Next, the film base 30 is stretched. The stretching is performed in one direction or two directions. Preferably, the stretching is performed in two directions, and the directions of the stretching are orthogonal to each other. Then, a coating liquid obtained by dissolving polyolefin as a raw material of the first adhesive layer 31 into a solvent is applied on at least one of surfaces of the stretched film base 30 to form a coating film on the film base 30. Then, the solvent is evaporated from the coating film by heating the coating film. Thus, the film base 30 having the first adhesive layer 31 on the surface thereof, namely, the multilayer film 22 is obtained. Note that, in the case where the cross-linking agent and acrylic resin are to be contained in the first adhesive layer 31, these may be contained in the coating liquid beforehand. Note that, in the case where the film base 30 is to be stretched in two directions, the film base 30 is stretched in one direction, and thereafter stretched in the other direction. The stretching of the film base 30 may be performed in two directions before the application of the coating liquid for forming the first adhesive layer 31. Alternatively, it is also possible to perform the stretching in one direction before the application of the coating liquid, and then perform the stretching in the other direction after the application thereof.

A method for applying the coating liquid is not particularly limited. For example, a known method such as a bar coating method or a slide coating method may be used. The solvent may be an aqueous solvent including water, toluene, methyl alcohol, isopropyl alcohol, methyl ethyl ketone, and a mixture of them, or an organic solvent. Of these, water is preferably used as the solvent in view of cost, easy production, and environment.

The coating liquid for producing the first adhesive layer 31 is applied on the biaxially-stretched film base 30. Thereby, the multilayer film 22 having uniform optical properties and good surface condition is obtained.

The prism sheet 20 is produced by the following method. In the case of using UV curable resin to form the prism layer 21, UV curable coating liquid which is cured by irradiation of ultraviolet rays is used. A mold for forming the prism layer is filled with the coating liquid, and then in a state that the coating liquid filled in the mold is in contact with the first adhesive layer 31 of the multilayer film 22, light is irradiated from the side of the film base 30 to cure the coating film. Note that, alternatively, it is also possible to apply the coating liquid for forming the prism layer 21 to the surface of the multilayer film 22 on the side near the first adhesive layer 31 to form the coating film, and press the mold for forming the prism layer against the surface of the coating film. In this case, in a state that the mold is pressed against the coating film, light is irradiated thereto from the side of the film base 30 to cure the coating film. Thereby, the prism sheet 20 provided with the multilayer film 22 and the prism layer 21 formed on the first adhesive layer 31 is obtained.

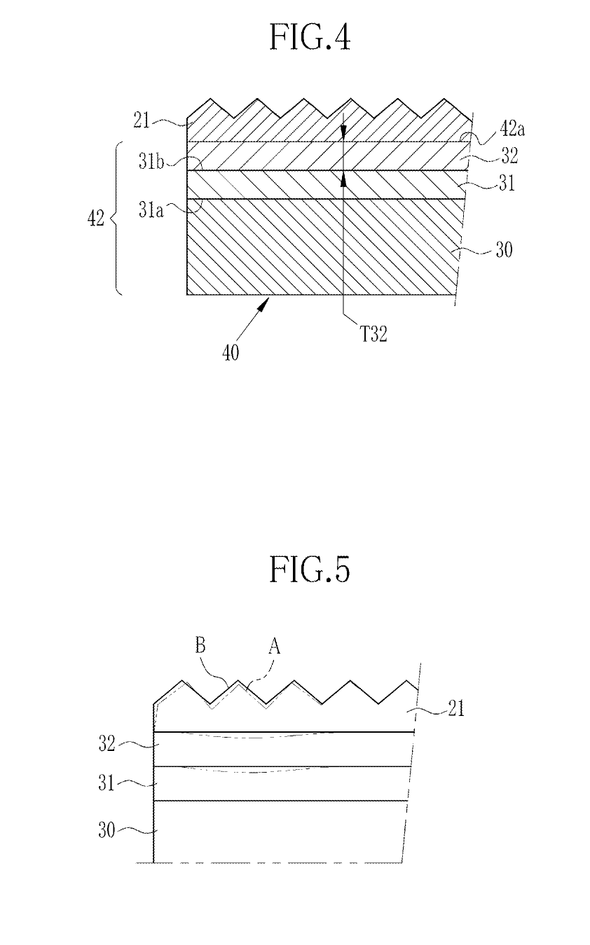

A multilayer film 42 shown in FIG. 4 includes the film base 30, the first adhesive layer 31, and a second adhesive layer 32. Note that, in FIG. 4, the same components and layers as those in FIGS. 2 and 3 are denoted by the same reference numerals used in FIGS. 2 and 3, and the explanation thereof is omitted. The first adhesive layer 31 has a first surface 31a in contact with the film base 30, and a second surface 31b on the opposite side from the first surface 31a. The second adhesive layer 32 is formed on the second surface 31b. An exposed surface of the second adhesive layer 32 of the multilayer film 42 is referred to as a first surface 42a, and the prism layer 21 is formed on the first surface 42a in a subsequent process, thus the a prism sheet 40 is obtained.

The second adhesive layer 32 is used to further increase the adhesive strength between the film base 30 and the prism layer 21. A thickness T32 of the second adhesive layer 32 is preferably in a range of not less than 0.1 μm to not more than 2.5 μm, more preferably in a range of not less than 0.2 μm to not more than 2.0 μm.

The second adhesive layer 32 is configured such that the coating liquid for forming the prism layer 21 permeates the second adhesive layer 32 during the process for forming the prism layer 21, specifically, during the period from the application of the coating liquid for forming the prism layer 21 to the curing of the coating liquid upon being irradiated with the light including the ultraviolet rays. Accordingly, the adhesive strength between the prism layer 21 formed by the curing of the coating liquid and the multilayer film 42 is stronger than the adhesive strength between the prism layer 21 and the multilayer film 22 (see FIGS. 2 and 3).

The second adhesive layer 32 is deformed in the similar manner as the prism layer 21 with little change in its thickness when the prism layer 21 elastically deforms. In contrast, as described above, the first adhesive layer 31 having a low elastic modulus is stretched or contracted, and follows the change in shape of the prism layer 21 when the prism layer 21 elastically deforms. For example, when the prism layer 21 deforms into a state shown by the double-dashed line A in FIG. 5 in a direction of being pressed against the film base 30, the second adhesive layer 32 deforms toward the film base 30 in the similar manner as the prism layer 21, and the first adhesive layer 31 contracts such that the thickness T31 thereof is decreased. Further, when the deformed prism layer 21 returns to its original shape shown by the solid line B in FIG. 5, the second adhesive layer 32 returns to its original shape in the similar manner as the prism layer 21 with keeping its thickness approximately uniform, and the first adhesive layer 31 returns to its original shape and has its original thickness. The first adhesive layer 31 has a property of returning to its original shape as described above, and therefore even when the shape of the prism layer 21 changes, the prism layer 21 is not peeled from the film base 30 such that the adhesion between the prism layer 21 and the film base 30 is maintained, and the second adhesive layer 32 makes it harder for the prism layer 21 to be peeled from the film base 30.

Preferred embodiments of the second adhesive layer 32 are described hereinbelow. The second adhesive layer 32 of the first embodiment contains a cross-linking agent, polyurethane, and polyester.

According to the first embodiment, polyester is preferably copolymerized polymer having a glass transition temperature Tg of less than 60° C., and at least 30% of dicarboxylic acid units in the copolymerized polymer have the naphthalene rings. while the glass transition temperature Tg of the copolymerized polymer contained in the second adhesive layer 32 is less than 60° C., the adhesive strength to the prism layer 21 is further increased. In particular, in the case where the prism layer 21 is formed from the coating liquid containing the compound having the structure represented by the general formula (1) and the compound having the structure represented by the general formula (2), the adhesive strength to the prism layer 21 is surely increased. The glass transition temperature Tg of the copolymerized polymer contained in the second adhesive layer 32 is preferably as low as possible in view of the improvement in the adhesive strength, and the preferable temperature thereof is 50° C., for example. However, the lowest temperature of the glass transition temperature Tg of the copolymerized polymer contained in the second adhesive layer 32 is approximately 0° C. for the purpose of maintaining the shape as the multilayer film 22 and the handling property thereof.

In the first embodiment, the polyester contained in the second adhesive layer 32 may be a mixture of two or more types of polyester. In this case, it is preferable that the mixture contains at least one type of polyester having the glass transition temperature Tg of less than 60° C. The polyester having the glass transition temperature Tg of 60° C. or more may be used together. However, the more the ratio of the polyester having the glass transition temperature Tg of 60° C. or more is increased, the more difficult it becomes for the coating liquid for forming the prism layer 21 to permeate the second adhesive layer 32 in the process of forming the prism layer 21, and therefore the degree of improvement in the adhesive strength is decreased. In view of the above, in the case where the second adhesive layer 32 contains polyester having the glass transition temperature Tg of 60° C. or more and polyester having the glass transition temperature Tg of less than 60° C., the concentration of the polyester having the glass transition temperature Tg of 60° C. or more in the second adhesive layer 32 is preferably at most 10 mass %, and more preferably, 5 mass %. In other words, the concentration of the polyester having the glass transition temperature Tg of less than 60° C. contained in the second adhesive layer 32 is preferably at least 90 mass %, and more preferably 95 mass %.

In the first embodiment, using the compound having the naphthalene rings as the polyester contained in the second adhesive layer 32 surely prevents bleeding out of the oligomer on the surface of the second adhesive layer 32. It is considered that high compatibility between an oligomer component of the film base 30 and the copolymerized polyester having the naphthalene rings prevents the bleeding out of the oligomer. Note that, in the first embodiment, the polyester having the glass transition temperature Tg of less than −20° C. is unstable and therefore not suitable for the second adhesive layer 32 in some cases. Therefore, the glass transition temperature Tg of the polyester contained in the second adhesive layer 32 is preferably at least −20° C. To be more specific, the glass transition temperature Tg of the polyester contained in the second adhesive layer 32 is preferably in a range of not less than −20° C. to not more than 60° C., and more preferably in a range of not less than −10° C. to not more than 50° C.

A method for measuring the glass transition temperature Tg is described in JIS K 7121 (1987).

The glass transition temperature Tg of the polyester having the naphthalene rings tends to be higher than that of the polyester with no naphthalene ring. Accordingly, the copolymerized polyester having the naphthalene rings and the glass transition temperature Tg of less than 60° C. is preferably the copolymerized polyester having dicarboxylic acid component expressed by a chemical formula (4) set forth below and diol component expressed by a chemical formula (5) set forth below.

HOOC—(CH₂)ₙ—COOH (“n” denotes a natural number satisfying 4≦n≦10) (4)

HO—(CH₂)ₘ—OH (“m” denotes a natural number satisfying 4≦m≦10) (5)

It is preferable that the polyester contains a 2,6-naphthalenedicarboxylic acid unit as the dicarboxylic acid unit. The polyester having the naphthalene rings and the glass transition temperature Tg of less than 60° C. may have a dicarboxylic acid unit expressed by the chemical formula (4), a terephthalic acid unit, or an isophthalic acid unit as the dicarboxylic acid unit.

It is preferable that a percentage “X1” of 2,6-naphthalenedicarboxylic acid units to the total dicarboxylic acid units in the polyester having the naphthalene rings is in a range of not less 30% to not more than 90%. In the case where the percentage X1 is less than 30%, the bleeding out of the oligomer cannot be prevented sufficiently in some cases. In the case where the percentage X1 is more than 90%, the glass transition temperature Tg of the copolymerized polyester increases, and this weakens the adhesive strength to the prism layer 21, particularly the adhesive strength to the prism layer 21 containing UV-curable acrylic resin, which is not preferable. The percentage X1 is more preferably in a range of not less than 40% to not more than 80%, and furthermore preferably in a range of not less than 50% to not more than 75%.

To prepare the polyester having the percentage X1 in the above-described range, it is preferable to make the percentage of the dicarboxylic acid units having the naphthalene rings to the total dicarboxylic acid units constituting the polyester the same as the percentage X1, namely, in a range of not less than 30 mol % to not more than 90 mol %. The percentage of the dicarboxylic acid units having the naphthalene rings to the total dicarboxylic acid units constituting the polyester is more preferably in a range of not less than 40 mol % to not more than 80 mol %, and furthermore preferably in a range of not less than 50 mol % to not more than 75 mol %.

The polyester preferably contains a diol unit that lowers the glass transition temperature Tg of the polyester. Examples of the diol unit include a diol unit expressed by the chemical formula (5), an ethylene glycol unit, a diethylene glycol unit, and a triethylene glycol unit.

A percentage X2 of the diol units expressed by the chemical formula (5) to the total diol units in the polyester is preferably in a range of not less than 10% to not more than 95%, and more preferably in a range of not less than 20% to not more than 90%, and furthermore preferably in a range of not less than 30% to not more than 85%. When the percentage X2 is less than 10%, the diol units cannot lower the glass transition temperature Tg sufficiently in some cases. As a result, the adhesive strength to the prism layer 21, particularly the adhesive strength to the prism layer 21 containing UV-curable acrylic resin decreases. When the percentage X2 exceeds 95%, on the other hand, a rate of polymerization may be lowered.

To prepare the polyester with the percentage X2 in the above-described range, a percentage of the diol units, expressed by the chemical formula (5), to the total diol units constituting the polyester is preferably in a range of not less than 10% to not more than 95% in the same manner as the percentage X2. Note that the percentage of the diol units, expressed by the chemical formula (5), to the total diol units constituting the polyester is more preferably in a range of not less than 20% to not more than 90%, and furthermore preferably in a range of not less than 30% to not more than 85%.

For example, Plas-Coat 2592 available from Goo Chemical Co., Ltd. can be used as the polyester in the present invention.

In stead of the first adhesive layer 31 having the above structure, the second adhesive layer 32 containing the polyurethane ensures the enough adhesive strength to the prism layer 21. In addition to the first adhesive layer 31 having the above structure, the second adhesive layer 32 containing the polyurethane further surely increases the adhesive strength to the prism layer 21. The polyurethane contained in the second adhesive layer 32 is a generic name for polymer having urethane bonds in amain chain, and normally obtained by a reaction between polyisocyanate and polyol. Examples of polyisocyanate include TDI (toluene diisocyanate), MDI (diphenylmethane diisocyanate), NDI (naphthalene diisocyanate), TODI (tolidine diisocyanate), HDI (hexamethylene diisocyanate) and IPDI (isophorone diisocyanate). Examples of polyol include ethylene glycol, propylene glycol, glycerin, and hexanetriol. In the present invention, isocyanate can be polymer with molecular weight increased by chain-extension process of polyurethane polymer obtained by the reaction between polyisocyanate and polyol. The polyisocyanate, the polyol, and the chain-extension process are described in “Polyurethane handbook” (edited by Keiji IWATA, published by Nikkan Kogyo Shinbunsha, 1987), for example. Note that the second adhesive layer 32 may contain one or more types of polyurethane.

The polyurethane contained in the second adhesive layer 32 preferably has the glass transition temperature Tg in a range of not less than −40° C. to not more than 50° C., and more preferably in a range of not less than −20° C. to not more than 40° C. When the glass transition temperature Tg of the polyurethane contained in the second adhesive layer 32 exceeds 50° C., it becomes difficult for the coating liquid for forming the prism layer 21, in particular the prism layer 21 containing the UV-curable acrylic resin expressed by the general formula (1) to permeate the second adhesive layer 32, and therefore the degree of improvement in adhesive strength to the prism layer 21 is decreased. When the glass transition temperature Tg of the polyurethane contained in the second adhesive layer 32 is less than −40° C., the polyurethane becomes unstable, which is not preferable.

For example, SUPERFLEX 150HS or SUPERFLEX 470 available from DAI-ICHI KOGYO SEIYAKU CO., LTD., HYDRAN AP-20, HYDRAN WLS-210, or HYDRAN HW-161 available from DIC Corporation may be used as the polyurethane for the present invention.

Examples of the cross-linking agent contained in the second adhesive layer 32 include isocyanate compounds, oxazoline compounds, carbodiimide compounds, melamine compounds, urea compounds, and epoxy compounds. Of these, the oxazoline compounds and the carbodiimide compounds are preferable in view of temporal stability of the coating liquid and the adhesive property after high temperature and high humidity treatment. The cross-linking agents may be used singly or in combination. Further, in the case where the optical functional layer such as the prism layer 21 is formed after the lapse of time, the cross-linking agent may not be contained in the second adhesive layer 32, in view of temporal stability of the first adhesive layer 31 and the second adhesive layer 32 during the storage of the multilayer film 42 for a long time.

As the isocyanate compounds, oxazoline compounds, and carbodiimide compounds contained in the second adhesive layer 32, the isocyanate compounds, oxazoline compounds, and carbodiimide compounds cited as the cross-linking agent for the first adhesive layer 31 can be used.

It is preferable to add the oxazoline compound in a range of more than 0 mass % to not more than 50 mass %, more preferably in a range of 5 mass % to 50 mass %, and furthermore preferably in a range of 10 mass % to 40 mass %, relative to the polymer component in the second adhesive layer 32. By adding the oxazoline compound in the above range, the high adhesive strength between the prism layer 21 and the film base 30 is more surely maintained even after the high temperature and high humidity treatment. On the other hand, in the case where the additional amount of the oxazoline compound is less than 5 mass %, the adhesive strength between the prism layer 21 and the film base 30 becomes defective with time under the high-temperature condition or under the high-temperature and high-humidity condition in some cases. When the additional amount of the oxazoline compound exceeds 50 mass %, in contrast, the stability of the coating liquid tends to deteriorate.

It is preferable to add the carbodiimide compounds in a range of more than 0 mass % to not more than 80 mass % relative to the polymer component in the second adhesive layer 32, more preferably in a range of 15 mass % to 80 mass %, and furthermore preferably in a range of 20 mass % to 75 mass %. By adding the carbodiimide compounds in the above range, the high adhesive strength between the prism layer 21 and the film base 30 is further surely maintained. On the other hand, in the case where the additional amount of the carbodiimide compound is less than 15 mass %, the degree of improvement in the adhesive strength between the prism layer 21 and the film base 30 is decreased. In contrast, when the additional amount of the carbodiimide compound exceeds 80 mass %, too much cost is incurred, although it causes no particular negative effect in view of the degree of adhesive strength.

The multilayer film 42 is produced by the following method. At first, the multilayer film 22 is produced by the method described above. The coating liquid obtained by dissolving polyester, polyurethane, and the cross-linking agent, which are raw materials of the second adhesive layer 32, into the solvent is applied on the first adhesive layer 31, so as to form a coating film. Then, the coating film is heated to evaporate the solvent from the coating film, and thereby the multilayer film 42 including the first adhesive layer 31 and the second adhesive layer 32 formed on the first adhesive layer 31 is produced. The coating method for forming the second adhesive layer 32 and the solvent for use in the method are not particularly limited, as in the case of the coating method for forming the first adhesive layer 31 and the solvent for use in the method. The same method as that for forming the first adhesive layer 31 and the same solvent as that for use in the method for forming the first adhesive layer 31 may be used as the coating method for forming the second adhesive layer 32 and the solvent for use in the method.

The prism sheet 40 is produced by applying the coating liquid for forming the prism sheet 21 on the second adhesive layer 32 of the multilayer film 42 so as to form the prism layer 21. The method for forming the prism layer 21 is the same as that for forming the prism layer 21 of the prism sheet 20 described above.

According to the second embodiment, the second adhesive layer 32 contains polyester having the glass transition temperature Tg of less than 60° C. Additionally, the dicarboxylic acid units in a range of not less than 10 mol % to not more than 40 mol % has unsaturated double bond.

The state in which the dicarboxylic acid units in a range of not less than 10 mol % to not more than 40 mol % has unsaturated double bond means that a percentage “X3” of the dicarboxylic acid units having unsaturated double bond to the total dicarboxylic acid units in the polyester is in a range of not less than 10% to not more than 50%. In the case where the X3 is at least 10%, the adhesive strength to the prism layer 21 is further increased in comparison with the case where the X3 is less than 10%. Further, in the case where the X3 is at most 50%, the stability of the coating liquid for forming the second adhesive layer 32 is further increased, and the second adhesive layer 32 more surely has a uniform thickness in comparison with the case where the X3 is more than 50%. In view of the stability of the coating liquid for forming the second adhesive layer 32, X3 is preferably in a range of not less than 10% to not more than 40%, and especially preferably in a range of not less than 10% to not more than 30%.

According to the second embodiment, the polyester of the second adhesive layer 32 having the glass transition temperature Tg of less than 60° C. is preferably the polyester made from the dicarboxylic acid component expressed by the chemical formula (4). Additionally, the dicarboxylic acid units may include terephthalic acid, isophthalic acid, biphenyldicarboxylic acid, succinic acid, 1,4-cyclohexanedicarboxylic acid, and the like. In this case, when the coating liquid for forming the prism layer 21 is applied, the coating liquid easily permeates the second adhesive layer 32.

It is preferable that the polyester contains 2,6-naphthalenedicarboxylic acid unit as the dicarboxylic acid unit. Here, a percentage “X4” of the 2,6-naphthalenedicarboxylic acid unit to the total dicarboxylic acid units in the polyester is preferably in a range of not less than 20% to not more than 80%. In the case where the X4 is at least 20%, the bleeding out of the oligomer is more surely prevented in comparison with the case where the X4 is less than 20%. In the case where the X4 is at most 80%, the glass transition temperature Tg of the polyester becomes higher in comparison with the case where the X4 is more than 80%, and as a result, the permeation amount of the coating liquid for forming the prism layer 21 into the second adhesive layer 32 increases, and thereby the adhesive strength between the second adhesive layer 32 and the prism layer 21 is further increased. The percentage X4 is more preferably in a range of not less than 30% to not more than 70%, and furthermore preferably in a range of not more than 40% to not less than 65%.

To prepare the polyester with the percentage X3 in the above-described range, it is preferable to make a percentage of the dicarboxylic acid units having the unsaturated double bond to the total dicarboxylic acid units constituting the polyester the same as the percentage X3, namely, in a range of not less than 10 mol % to not more than 50 mol %. Note that the percentage of the dicarboxylic acid units having the unsaturated double bond to the total dicarboxylic acid units in the polyester is more preferably in a range of not less than 10 mol % to not more than 40 mol %, and especially preferably in a range of not less than 10 mol % to not more than 30 mol %.

To prepare the polyester with the percentage X4 in the above-described range, it is preferable to make a percentage of the dicarboxylic acid units having the naphthalene rings to the total dicarboxylic acid units constituting the polyester the same as the percentage X4, namely, in a range of not less than 20 mol % to not more than 80 mol %. Note that, the percentage of the dicarboxylic acid units having the naphthalene rings to the total dicarboxylic acid units constituting the polyester is more preferably in a range of not less than 30 mol % to not more than 70 mol %, and especially preferably in a range of not less than 40 mol % to not more than 65 mol %.

According to the second embodiment, the preferable diol component in the polyester in the second adhesive layer 32 may be the same as the diol component in the polyester in the second adhesive layer 32 according to the first embodiment, or neopentyl glycol, 1,3-propanediol, 1,4-butanediol, 1,4-cyclohexanedimethanol, or the like.

The first adhesive layer 31 may be disposed on not only one of surfaces of the film base 30 but also the other of surfaces of the film base 30. For example, an optical functional layer different from the prism layer 21 may be disposed on the other surface of the film base 30. Further, in the case where the first adhesive layer 31 is also disposed on the other surface of the film base 30, the second adhesive layer 32 may be disposed on the first adhesive layer 31 on the other surface of the film base 30.

Examples of the optical functional layer provided opposite to the prism layer 21 include an interference fringe prevention layer disclosed in Japanese Patent Laid-Open Publication No. 10(1998)-300908, a damage prevention layer disclosed in U.S. Patent Application Publication No. 2008/0248256 (corresponding to Published Japanese translation of PCT application No. 2007-529780), a layer for preventing contact damage caused by contact with prism peaks disclosed in U.S. Patent Application Publication No. 2010/0021731 (corresponding to Japanese Patent Laid-Open Publication No. 2010-49243), and a layer for preventing rainbow unevenness.

Note that, in the case where the first adhesive layer 31 is disposed on the respective surfaces of the film base 30, the coating liquid for forming the first adhesive layer 31 may be applied on the respective surfaces of the film base 30.

Note that, various kinds of additive agents may be contained in the first adhesive layer 31 and the second adhesive layer 32. A matting agent, a surface active agent, a lubricating agent, a preservative, or the like may be used as an additive agent.

The matting agent may be organic or inorganic fine particles. For example, polymer fine particles such as polystyrene, polymethyl methacrylate, silicone resin, or benzoguanamine resin, or inorganic fine particles such as silica, calcium carbonate, magnesium oxide, or magnesium carbonate may be used. Of these, in view of lubrication improvement and cost, polystyrene, polymethyl methacrylate, and silica are preferable.

An average particle diameter of the matting agent is preferably in a range of 0.01 μm to 12 μm, and more preferably in a range of 0.03 μm to 9 μm. Thereby, the lubrication improvement can be effected sufficiently without causing degradation in display quality of the display device. Two or more kinds of matting agents with different average particle diameters may be used in combination.

Although depending on the average particle diameter, the additional amount of the matting agent is preferably in a range of 0.1 mg/m² to 100 mg/m², and more preferably in a range of 0.5 mg/m² to 50 mg/m². Thereby, the lubrication improvement can be effected sufficiently without causing degradation in display quality of the display device.

The surface active agent may be of a known anionic type, a known nonionic type, or a known cationic type. The surface active agents are described in, for example, “Handbook of Surface Active Agent” (edited by Ichiro Nishi, Ichiro Imai, and Masatake Kasai, Published by Sangyo Tosho Publishers, Inc., 1960). The additional amount of the surface active agent is preferably in a range of 0.1 mg/m² to 30 mg/m², and more preferably in a range of 0.2 mg/m² to 10 mg/m². Thereby, the surfaces of the first adhesive layer 31 and the second adhesive layer 32 are maintained in good condition without repelling.

Examples of the lubricating agent include synthesized and natural wax, silicone compounds, and R—O—SO₃M (“R” denotes substituted or non-substituted alkyl group. The number of carbons in the alkyl group is an integer in a range of 3 to 20. “M” denotes a monovalent metal atom).

To be more specific, the examples of the lubricating agent include wax such as SEROZOL 524, 428, 732-B, 920, B-495, HYDRIN P-7, D-757, Z-7-30, E-366, F-115, D-336, D-337, POLYRON A, 393, H-481, HIMICRON G-110F, 930, G-270 (available from Chukyo Yushi Co., Ltd.), CHEMIPEARL W100, W200, W300, W400, W500, and W950 (available from Mitsui Chemicals Inc.), silicones such as KF-412, 413, 414, 393, 859, 8002, 6001, 6002, 857, 410, 910, 851, X-22-162A, X-22-161A, X-22-162C, X-22-160AS, X-22-164B, X-22-164C, X-22-170B, X-22-800, X-22-819, X-22-820, and X-22-821, (available from Shin-Etsu Chemical Co., Ltd.), and compounds such as C₁₆H₃₃—O—SO₃Na, and C₁₈H₃₇—O—SO₃Na expressed by the above-described general formula. It is preferable to add the lubricating agent in a range of 0.1 mg/m² to 50 mg/m², and more preferably in a range of 1 mg/m² to 20 mg/m². Thereby, sufficient lubrication property is obtained while the surfaces of the first adhesive layer 31 and the second adhesive layer 32 are maintained in good condition.

The prism layer 21 as the optical functional layer is formed in the above embodiment. However, also in the case where another optical functional layer is provided instead of the prism layer 21, the first adhesive layer 31 and the second adhesive layer 32 exhibit the same effect as in the case of using the prism layer 21. For example, in the case where a micro lens layer, in which a plurality of lenses are arranged to make a surface, has a low elastic modulus and returns to its original shape, the multilayer films 22 and 42 of the present invention exhibit the same effect as in the case of using the prism layer 21. Additionally, in the case where the hard coat for giving scratch resistance has a low elastic modulus and returns to its original shape, the multilayer films 22 and 42 of the present invention exhibit the same effect as in the case of using the prism layer 21.

Hereinafter, the present invention is specifically described with reference to examples. Example 1 is described in detail. As to Examples 2 to 7 and Comparative Examples 1 to 5, the descriptions of conditions different from those of Example 1 are described.

### Example 1

### Production of Base Film

The film base 30 was produced by the following the steps described below. First, polyethylene terephthalate (hereinafter referred to as PET) with the specific viscosity of 0.64, subjected to polycondensation using Ti compound as a catalyst, was dried to have water content of 50 ppm or less. Then, the dried PET was melted in an extruder at a heater temperature in a range of not less than 280° C. to not more than 300° C. The melted PET was extruded from a die section onto a chill roll, to which static electric was applied, to produce a belt-like amorphous base. The obtained amorphous base was stretched to 3.3 times in a lengthwise direction and 3.8 times in a widthwise direction. Thus, the film base 30 with the thickness of 188 μm was produced.

While the film base 30 was conveyed at a conveying speed of 60 m/min, each surface of the film base 30 was subjected to corona discharge treatment of 730 J/m². A coating liquid A described below was applied on one of the surfaces of the film base 30 using a bar coating method. The applied coating liquid A was dried at 145° C. for 1 minute. Thereby, the first adhesive layer 31 was formed on one of the surfaces of the film base 30. Further, each surface of the film base 30 was subjected to corona discharge treatment of 288 J/m². A coating liquid B described below was applied on the first adhesive layer 31 using a bar coating method. The applied coating liquid B was dried at 145° C. for 1 minute. Thereby, the multilayer film 42 having the first adhesive layer 31 and the second adhesive layer 32 formed on the first adhesive layer 31 was obtained.

(Coating Liquid A)

Composition of the coating liquid A was as follows.

| | | |
|---|---|---|
| Copolymer of acrylic acid ester | 63.4 | parts by mass |
| (JURYMER ET-410 available from TOAGOSEI | | |
| CO., LTD., solid content of 30%) | | |
| Polyolefin | 95.1 | parts by mass |
| (ARROW BASE SE-1013N available from | | |
| UNITIKA LTD., solid content of 20%) | | |
| Cross-linking agent (carbodiimide compound) | 31.5 | parts by mass |
| (CARBODILITE V-02-L2 available from | | |
| Nisshinbo Chemical Inc., solid content | | |
| of 40%) | | |
| Surface active agent A | 16.7 | parts by mass |
| (1% aqueous solution of NAROACTY | | |
| CL-95 available from Sanyo Chemical | | |
| Industries, Ltd.) | | |
| Surface active agent B | 6.9 | parts by mass |
| (1% aqueous solution of RAPISOL | | |
| B-90 available from NOF Corporation) | | |
| Aqueous dispersion of polystyrene latex | 1.2 | parts by mass |
| (Nipol UFN1008 available from ZEON | | |
| CORPORATION) | | |
| Preservative | 0.8 | parts by mass |
| (AF-337 available from DAITO CHEMICAL | | |
| CO., LTD., solid content of 3.5%, | | |
| methanol solvent) | | |
| Distilled water | ∝ | parts by mass |
| (“∝” was adjusted to make the total | | |
| amount of the coating liquid A to be | | |
| 1000 parts by mass.) | | |

(Coating Liquid B)

Composition of the coating liquid B was as follows.

| | | |
|---|---|---|
| Aqueous dispersion of polyester | 77.6 | parts by mass |
| (Plas-Coat Z592 available from Goo | | |
| Chemical Co., Ltd., solid content of 25%) | | |
| Polyurethane resin | 51.1 | parts by mass |
| (SUPERFLEX 150HS available from | | |
| DAI-ICHI KOGYO SEIYAKU CO., LTD., | | |
| solid content of 38%) | | |
| Cross-linking agent (oxazoline compound) | 15.3 | parts by mass |
| (EPOCROS K-2020E available from | | |
| NIPPON SHOKUBAI CO., LTD., solid | | |
| content of 40%) | | |
| Surface active agent A | 29.7 | parts by mass |
| (1% aqueous solution of NAROACTY | | |
| CL-95 available from Sanyo Chemical | | |
| Industries, Ltd.) | | |
| Surface active agent B | 12.3 | parts by mass |
| (1% aqueous solution of RAPISOL | | |
| B-90 avaiable from NOF Corporation) | | |
| Lubricating agent | 1.8 | parts by mass |
| (carnauba wax dispersion SEROZOL | | |
| 524 available from Chukyo Yushi | | |
| Co., Ltd., solid content of 30%) | | |
| Preservative | 0.7 | parts by mass |
| (AF-337 available from DAITO | | |
| CHEMICAL CO., LTD., solid content | | |
| of 3.5%, methanol solvent) | | |
| Distilled water | ∝ | parts by mass |
| (“∝” was adjusted to make the total | | |
| amount of the coating liquid B to be | | |
| 1000 parts by mass.) | | |

The mold for forming a prism pattern was filled with a coating liquid for forming the prism layer 21 (hereinafter referred to as prism-layer forming coating liquid) PA described below. The prism-layer forming coating liquid PA contained a UV curable compound. The multilayer film 42 was pressed against the mold by a roller such that the second adhesive layer 32 of the multilayer film 42 was made in contact with the coating liquid on the mold. Then, the ultraviolet rays of 1,000 mJ/cm² were irradiated to the second adhesive layer 32 from the film base 30 side after the lapse of 3 seconds from the start of contact between the second adhesive layer 32 and the coating liquid. Thereby, the UV curable compound was cured. A metal halide lamp UVL-1500M2 available from USHIO INC. was used as the light source for the irradiation of the ultraviolet rays. Then, the multilayer film 42 was peeled off from the mold. Thus, the prism sheet 40, being the multilayer film 42 having the prism layer 21, was obtained. The prism layer 21 had a vertical angle of 90°, a pitch of 60 μm, and height of 30 μm.

(Prism-Layer Forming Coating Liquid PA)

A composition of the prism-layer forming coating liquid PA was as follows.

| | | |
|---|---|---|
| Bisphenol A diacrylate resin | 57.0 | parts by mass |
| (NK Ester A-BPE-10 available from Shin- | | |
| Nakamura Chemical Co., Ltd.) | | |
| Bisphenol A diacrylate resin | 5.0 | parts by mass |
| (NK Ester A-BPE-4 available from Shin- | | |
| Nakamura Chemical Co., Ltd.) | | |
| Ethoxylated o-phenylphenol acrylate | 35.0 | parts by mass |
| (NK Ester A-LEN-10 available from Shin- | | |
| Nakamura Chemical Co., Ltd.) | | |
| Initiator (IRGACURE184) | 3 | parts by mass |

The following measurement and evaluation were made on the obtained prism sheet 40 and evaluation samples of the first adhesive layer 31 and the prism layer 21. Respective results are shown in Tables 1-1 and 1-2.

1. Evaluation of Adhesive Strength

Using a single-edge razor, 11 lines were drawn in each of horizontal and vertical directions on the prism layer 21 of the prism sheet 40 immediately after being produced to make 100 squares. Then, an adhesive tape (“600” available from 3M) was affixed to the prism layer 21 so as to cover the 100 squares. The tape was completely attached to the prism layer 21 by rubbing the tape with an eraser. Thereafter, the tape was peeled off in a direction 90 degrees to the horizontal plane. Adhesive strength of the prism layer 21 to the film base 30 was evaluated by the following 5 stages A to E depending on the number of squares peeled off with the tape.

A: No square was peeled.
B: The number of squares peeled off was in a range of 1 or more to less than 5.
C: The number of squares peeled off was in a range of 5 or more to less than 15.
D: The number of squares peeled off was in a range of 15 or more to less than 30.
E: The number of squares peeled off was 30 or more

Note that the “A” or “B” denotes a level acceptable as a product, and “C”, “D”, or “E” denotes a level unacceptable as a product.

2. Measurement of Elastic Modulus and Fracture Elongation

Evaluation samples each having a width of 5 mm and a thickness of 20 μm were produced under the conditions for producing the samples described below based on ASTM D882. The thickness 20 μm means the thickness of the evaluation sample of the first adhesive layer 31 in the case of measuring the elastic modulus and fracture elongation of the first adhesive layer 31. The thickness 20 μm means the thickness of the evaluation sample of the prism layer 21 in the case of measuring the elastic modulus and fracture elongation of the prism layer 21.

The coating liquid A for use in forming the first adhesive layer 31 was applied on a base to form a film on the base under the same conditions as those for forming the first adhesive layer 31, and the resultant film was peeled from the base. Thereby, the evaluation sample of the first adhesive layer 31 was obtained. Cerapeel HP2 available from TORAY INDUSTRIES was used as the base. Further, the prism-layer forming coating liquid PA was applied on the base to form a film on the base under the same conditions as those for forming the prism layer 21, and the resultant film was peeled from the base. Thereby, the evaluation sample of the prism layer 21 was obtained. Cerapeel HP2 available from TORAY INDUSTRIES was used as the base. The elastic modulus and fracture elongation representing the tensile property of each of the evaluation samples were measured by using Tensilon RTM-50 available from ORIENTEC Co., LTD at the width of 5 mm, a distance between chucks of 20 mm, and a tension rate of 5 mm/min under the room temperature (23° C., relative humidity of 50%).

3. Thickness T31 of First Adhesive Layer and Thickness T32 of Second Adhesive Layer

A microtome (RM2255, available from Leica Microsystems) was used to cut a section of the multilayer film 42 before the prism layer 21 was formed. The section of the multilayer film 42 was observed using a scanning electron microscope (S-4700 available from HITACHI, Ltd.) to measure the thickness T31 of the first adhesive layer 31 and the thickness T32 of the second adhesive layer 32. The thickness T31 of the first adhesive layer 31 and the thickness T32 of the second adhesive layer 32 are respectively shown in a field of “thickness” of the first adhesive layer and a field of “thickness” of the second adhesive layer in Tables 1-1 and 1-2. Note that “total thicknesses of adhesive layers” in Table 1-2 means the total of the thickness T31 of the first adhesive layer 31 and the thickness T32 of the second adhesive layer 32.

The numerical value in the field “polyolefin” in Table 1-1 means the solid content mass of the polyolefin when the total solid content mass of the first adhesive layer 31 from which the solid content mass of the additive agents is subtracted is considered as 100. The numerical value in the field “acrylic resin” means the solid content mass of the acrylic when the total solid content mass of the first adhesive layer 31 from which the solid content mass of the additive agents is subtracted is considered as 100. The numerical value in the field “cross-linking agent” means the solid content mass of the cross-linking agent when the total solid content mass of the first adhesive layer 31 from which the solid content mass of the additive agents is subtracted is considered as 100.

TABLE 1-1

| | First adhesive layer | | | | | | |
|---|---|---|---|---|---|---|---|
| | | Acrylic | Poly- | | Thickness | EM | FE |
| | polyolefin | resin | ester | CLA | (μm) | (Mpa) | (%) |
| E1 | 37.5 | 37.5 | — | 25 | 0.45 | 400 | 80 |
| E2 | 37.5 | 37.5 | — | 25 | 0.45 | 400 | 80 |
| E3 | 90 | 5 | — | 5 | 0.45 | 300 | 30 |
| E4 | 75 | — | — | 25 | 0.45 | 300 | 50 |
| E5 | 10 | 65 | — | 25 | 0.45 | 300 | 15 |
| CE1 | — | 75 | — | 25 | 0.45 | 350 | 4 |
| CE2 | — | — | 20 | 80 | 0.45 | 800 | 20 |
| CE3 | 37.5 | 37.5 | — | 25 | 0.05 | 400 | 80 |
| E6 | 37.5 | 37.5 | — | 25 | 0.10 | 400 | 80 |
| E7 | 37.5 | 37.5 | — | 25 | 3.00 | 400 | 80 |
| CE4 | — | 37.5 | 37.5 | 25 | 0.45 | 750 | 3 |
| CE5 | — | 37.5 | 37.5 | 25 | 0.45 | 750 | 3 |

Abbreviations
E: Example
CE: Comparative Example
CLA: Cross-linking agent
EM: elastic modulus
FE: fracture elongation

TABLE 1-2

| | Second adhesive layer | | | Prism layer | |
|---|---|---|---|---|---|
| | | Thickness | TTAL | EM | |
| | W or W/O | (μm) | (μm) | (Mpa) | ASE |
| E1 | W | 0.45 | 0.90 | 100 | A |
| E2 | W/O | — | 0.45 | 100 | B |
| E3 | W | 0.45 | 0.90 | 100 | C |
| E4 | W | 0.45 | 0.90 | 100 | B |
| E5 | W | 0.45 | 0.90 | 100 | C |
| CE1 | W | 0.45 | 0.90 | 100 | D |
| CE2 | W/O | — | 0.45 | 100 | E |
| CE3 | W | 0.45 | 0.05 | 100 | D |
| E6 | W | 0.45 | 0.55 | 100 | C |
| E7 | W | 0.45 | 3.45 | 100 | B |
| CE4 | W | 0.45 | 0.90 | 100 | D |
| CE5 | W | 0.45 | 0.90 | 1000 | B |

Abbreviations
E: Example
CE: Comparative Example
W or W/O: with or without
TTAL: Total thickness of adhesive layers
ASE: Adhesive strength evaluation
EM: elastic modulus

### Example 2

While the same film base 30 as that in Example 1 was conveyed at a conveying speed of 60 m/min, each surface of the film base 30 was subjected to corona discharge treatment of 730 J/m². Then, the coating liquid A was applied on one of the surfaces of the film base 30 using a bar coating method. The applied coating liquid A was dried at 145° C. for 1 minute. Thereby, the first adhesive layer 31 was formed on one of the surfaces of the film base 30, such that the multilayer film 22 was formed. The thickness of the first adhesive layer 31 is shown in Table 1-1. The same prism-layer forming coating liquid as that in Example 1 was applied on the first adhesive layer 31 of the multilayer film 22 so as to form the prism layer 21 under the same conditions as those in Example 1. Thereby, the prism sheet 20 was obtained.

The measurement and evaluation were made on the obtained prism sheet 20 and evaluation samples of the first adhesive layer 31 and the prism layer 21 using the same method and criteria as those in Example 1. The results are shown in Tables 1-1 and 1-2. Note that, in this example, the second adhesive layer 32 was not formed, and therefore the field of “thickness” of “second adhesive layer” in Table 1-2 is filled with a symbol “-”.

### Example 3

The coating liquid A used in Example 1 was substituted with the following coating liquid C. The other conditions were the same as those in Example 1. Thus, the prism sheet 40 was obtained.

(Coating Liquid C)

Composition of the coating liquid C was as follows.

| | | |
|---|---|---|
| Copolymer of acrylic acid ester | 8.5 | parts by mass |
| (JURYMER ET-410 available from TOAGOSEI | | |
| CO., LTD., solid content of 30%) | | |
| Polyolefin | 228.3 | parts by mass |
| (ARROW BASE SE-1013N available from | | |
| UNITIKA LTD., solid content of 20%) | | |
| Cross-linking agent (carbodiimide compound) | 6.3 | parts by mass |
| (CARBODILITE V-02-L2 available from | | |
| Nisshinbo Chemical Inc., solid content | | |
| of 40%) | | |
| Surface active agent A | 16.7 | parts by mass |
| (1% aqueous solution of NAROACTY CL-95 | | |
| available from Sanyo Chemical Industries, Ltd.) | | |
| Surface active agent B | 6.9 | parts by mass |
| (1% aqueous solution of RAPISOL B-90 | | |
| available from NOF Corporation) | | |
| Aqueous dispersion of polystyrene latex | 1.2 | parts by mass |
| (Nipol UFN1008 available from ZEON | | |
| CORPORATION) | | |
| Preservative | 0.8 | parts by mass |
| (AF-337 available from DAITO CHEMICAL | | |
| CO., LTD., solid content of 3.5%, methanol | | |
| solvent) | | |
| Distilled water | ∝ | parts by mass |
| (“∝” was adjusted to make the total amount | | |
| of the coating liquid C to be 1000 parts | | |
| by mass.) | | |

The measurement and evaluation were made on the obtained prism sheet 20 and evaluation samples of the first adhesive layer 31 and the prism layer 21 using the same method and criteria as those in Example 1. The results are shown in Tables 1-1 and 1-2.

### Example 4

The coating liquid A used in Example 1 was substituted with the following coating liquid D. The other conditions were the same as those in Example 1. Thus, the prism sheet 40 was obtained.

(Coating Liquid D)

Composition of the coating liquid D was as follows.

| | | |
|---|---|---|
| Polyolefin | 190.2 | parts by mass |
| (ARROW BASE SE-1013N available from | | |
| UNITIKA LTD., solid content of 20%) | | |
| Cross-linking agent (carbodiimide compound) | 31.5 | parts by mass |
| (CARBODILITE V-02-L2 available from | | |
| Nisshinbo Chemical Inc., solid content of 40%) | | |
| Surface active agent A | 16.7 | parts by mass |
| (1% aqueous solution of NAROACTY CL-95 | | |
| available from Sanyo Chemical Industries, Ltd.) | | |
| Surface active agent B | 6.9 | parts by mass |
| (1% aqueous solution of RAPISOL B-90 | | |
| available from NOF Corporation) | | |
| Aqueous dispersion of polystyrene latex | 1.2 | parts by mass |
| (Nipol UFN1008 available from ZEON | | |
| CORPORATION) | | |
| Preservative(AF-337 available from DAITO | 0.8 | parts by mass |
| CHEMICAL CO., LTD., solid contentof 3.5%, | | |
| methanol solvent) | | |
| Distilled water | ∝ | parts by mass |
| (“∝” was adjusted to make the total amount | | |
| of the coating liquid D to be 1000 parts by mass.) | | |

The measurement and evaluation were made on the obtained prism sheet 20 and evaluation samples of the first adhesive layer 31 and the prism layer 21 using the same method and criteria as those in Example 1. The results are shown in Tables 1-1 and 1-2.

### Example 5

The coating liquid A used in Example 1 was substituted with the following coating liquid E. The other conditions were the same as those in Example 1. Thus, the prism sheet 40 was obtained.

(Coating Liquid E)

Composition of the coating liquid E was as follows.

| | | |
|---|---|---|
| Copolymer of acrylic acid ester | 109.9 | parts by mass |
| (JURYMER ET-410 available from TOAGOSEI | | |
| CO., LTD., solid content of 30%) | | |
| Polyolefin | 25.3 | parts by mass |
| (ARROW BASE SE-1013N available from | | |
| UNITIKA LTD., solid content of 20%) | | |
| Cross-linking agent (carbodiimide compound) | 31.5 | parts by mass |
| (CARBODILITE V-02-L2 available from | | |
| Nisshinbo Chemical Inc., solid content of 40%) | | |
| Surface active agent A | 16.7 | parts by mass |
| (1% aqueous solution of NAROACTY CL-95 | | |
| available from Sanyo Chemical Industries, Ltd.) | | |
| Surface active agent B | 6.9 | parts by mass |
| (1% aqueous solution of RAPISOL B-90 | | |
| available from NOF Corporation) | | |
| Aqueous dispersion of polystyrene latex | 1.2 | parts by mass |
| (Nipol UFN1008 available from ZEON | | |
| CORPORATION) | | |
| Preservative | 0.8 | parts by mass |
| (AF-337 available from DAITO CHEMICAL | | |
| CO., LTD., solid content of 3.5%, methanol | | |
| solvent) | | |
| Distilled water | ∝ | parts by mass |
| (“∝” was adjusted to make the total amount of | | |
| the coating liquid E to be 1000 parts by mass.) | | |

The measurement and evaluation were made on the obtained prism sheet 20 and evaluation samples of the first adhesive layer 31 and the prism layer 21 using the same method and criteria as those in Example 1. The results are shown in Tables 1-1 and 1-2.

### Comparative Example 1

The coating liquid A used in Example 1 was substituted with the following coating liquid F. The other conditions were the same as those in Example 1, and a prism sheet was obtained.

(Coating Liquid F)

Composition of the coating liquid F was as follows.

| | | |
|---|---|---|
| Copolymer of acrylic acid ester | 126.8 | parts by mass |
| (JURYMER ET-410 available from TOAGOSEI | | |
| CO., LTD., solid content of 30%) | | |
| Cross-linking agent (carbodiimide compound) | 31.5 | parts by mass |
| (CARBODILITE V-02-L2 available from | | |
| Nisshinbo Chemical Inc., solid content of 40%) | | |
| Surface active agent A | 16.7 | parts by mass |
| (1% aqueous solution of NAROACTY CL-95 | | |
| available from Sanyo Chemical Industries, Ltd.) | | |
| Surface active agent B | 6.9 | parts by mass |
| (1% aqueous solution of RAPISOL B-90 | | |
| available from NOF Corporation) | | |
| Aqueous dispersion of polystyrene latex | 1.2 | parts by mass |
| (Nipol UFN1008 available from ZEON | | |
| CORPORATION) | | |
| Preservative | 0.8 | parts by mass |
| (AF-337 available from DAITO CHEMICAL | | |
| CO., LTD., solid content of 3.5%, methanol | | |
| solvent) | | |
| Distilled water | ∝ | parts by mass |
| (“∝” was adjusted to make the total amount of | | |
| the coating liquid F to be 1000 parts by mass.) | | |

The measurement and evaluation were made on the obtained prism sheet and evaluation samples of the first adhesive layer and the prism layer using the same method and criteria as those in Example 1. The results are shown in Tables 1-1 and 1-2.

### Comparative Example 2

The coating liquid A used in Example 1 was substituted with the following coating liquid G. The coating liquid G after being applied was dried to form the first adhesive layer at 130° C. for 1 minute and then at 224° C. for 5 seconds, instead of 145° C. for 1 minute. The other conditions were the same as those in Example 2, and a prism sheet was obtained.

The coating liquid G was prepared using the following method and prescription. 95 parts by mass of dimethyl terephthalate, 95 parts by mass of dimethyl isophthalate, 35 parts by mass of ethylene glycol, 145 parts by mass of neopentyl glycol, 0.1 parts by mass of zinc acetate, and 0.1 parts by mass of antimony trioxide were put into a reaction container, and subjected to transesterification reaction at 180° C. for 3 hours. Next, 6.0 parts by mass of 5-sodium isophthalic acid was added thereto, and the resultant was subjected to transesterification reaction at 240° C. for 1 hour and then subjected to polycondensation reaction. Thereby, polyester was obtained. 6.7 parts by mass of aqueous dispersion containing 30 mass % of the obtained polyester, 40 parts by mass of aqueous solution containing 20 mass % of self-crosslinking polyurethane having an isocyanate group blocked by sodium bisulfite (ELASTRON H-3 available from Dai-ichi Kogyo Seiyaku Co., Ltd.), 0.5 parts by mass of catalyst for elastron (Cat 64 available from Dai-ichi Kogyo Seiyaku Co., Ltd.), 47.8 parts by mass of water, and 5 parts by mass of isopropyl alcohol were mixed together, and to this were further added 1 mass % of an anionic surfactant, and 5 mass % of colloidal silica particles (SNOWTEX OL available from NISSAN CHEMICAL INDUSTRIES, LTD). Thereafter, the resultant was subjected to precision filtration through a felt-type filtering member made of polypropylene having a filtering particle size of 25 μm (initial filtering efficiency: 95%), and thereby the coating liquid G was obtained.

The measurement and evaluation were made on the obtained prism sheet and evaluation samples of the first adhesive layer and the prism layer using the same method and criteria as those in Example 1. Note that, in this comparative example, the second adhesive layer was not formed, and therefore the field of “thickness” of “second adhesive layer” in Table 1-2 is filled with a symbol “-”.

### Comparative Example 3

A first adhesive layer having a thickness shown in Table 1-1 instead of the thickness of the first adhesive layer 31 of Example 1 was formed. The other conditions were the same as those in Example 1, and a prism sheet was obtained.

The measurement and evaluation were made on the obtained prism sheet and evaluation samples of the first adhesive layer and the prism layer using the same method and criteria as those in Example 1. The results are shown in Tables 1-1 and 1-2.

### Example 6

The first adhesive layer 31 having a thickness shown in Table 1-1 instead of the thickness of the first adhesive layer 31 of Example 1 was formed. The other conditions were the same as those in Example 1, and the prism sheet 40 was obtained.

The measurement and evaluation were made on the obtained prism sheet 40 and evaluation samples of the first adhesive layer 31 and the prism layer 21 using the same method and criteria as those in Example 1. The results are shown in Tables 1-1 and 1-2.

### Example 7

The first adhesive layer 31 having a thickness shown in Table 1-1 instead of the thickness of the first adhesive layer 31 of Example 1 was formed. The other conditions were the same as those in Example 1, and the prism sheet 40 was obtained.

The measurement and evaluation were made on the obtained prism sheet 40 and evaluation samples of the first adhesive layer 31 and the prism layer 21 using the same method and criteria as those in Example 1. The results are shown in Tables 1-1 and 1-2.

### Comparative Example 4

The coating liquid A used in Example 1 was substituted with the following coating liquid H. The other conditions were the same as those in Example 1, and a prism sheet was obtained.

(Coating Liquid H)

Composition of the coating liquid H was as follows.

| | | |
|---|---|---|
| Copolymer of acrylic acid ester | 63.4 | parts by mass |
| (JURYMER ET-410 available from TOAGOSEI | | |
| CO., LTD., solid content of 30%) | | |
| Aqueous dispersion of polyester | 76.1 | parts by mass |
| (Plas-Coat Z687 available from Goo Chemical | | |
| Co., Ltd., solid content of 25%) | | |
| Cross-linking agent (carbodiimide compound) | 31.5 | parts by mass |
| (CARBODILITE V-02-L2 available from | | |
| Nisshinbo Chemical Inc., solid content of 40%) | | |
| Surface active agent A | 16.7 | parts by mass |
| (1% aqueous solution of NAROACTY CL-95 | | |
| available from Sanyo Chemical Industries, Ltd.) | | |
| Surface active agent B | 6.9 | parts by mass |
| (1% aqueous solution of RAPISOL B-90 | | |
| available from NOF Corporation) | | |
| Aqueous dispersion of polystyrene latex | 1.2 | parts by mass |
| (Nipol UFN1008 available from ZEON | | |
| CORPORATION) | | |
| Preservative | 0.8 | parts by mass |
| (AF-337 available from DAITO CHEMICAL | | |
| CO., LTD., solid content of 3.5%, methanol | | |
| solvent) | | |
| Distilled water | ∝ | parts by mass |
| (“∝” was adjusted to make the total amount | | |
| of the coating liquid H to be 1000 parts by mass.) | | |

The measurement and evaluation were made on the obtained prism sheet and evaluation samples of the first adhesive layer and the prism layer using the same method and criteria as those in Example 1. The results are shown in Tables 1-1 and 1-2.

### Comparative Example 5

The prism-layer forming coating liquid PA used in comparative example 4 was substituted with the following prism-layer forming coating liquid PB. The other conditions were the same as those in comparative example 4, and a prism sheet was obtained.

(Prism-Layer Forming Coating Liquid PB)

Composition of the prism-layer forming coating liquid PB was as follows.

| | |
|---|---|
| Bisphenol A diacrylate resin | 65.0 parts by mass |
| (NK Ester A-BPE-4 available from Shin- | |
| Nakamura Chemical Co., Ltd.) | |
| Ethoxylated o-phenylphenol acrylate | 32.0 parts by mass |
| (NK Ester A-LEN-10 available from Shin- | |
| Nakamura Chemical Co., Ltd.) | |
| Initiator (IRGACURE184) | 3 parts by mass |

The measurement and evaluation were made on the obtained prism sheet and evaluation samples of the first adhesive layer and the prism layer using the same method and criteria as those in Example 1. The results are shown in Tables 1-1 and 1-2.

Various changes and modifications are possible in the present invention and may be understood to be within the present invention.

What is claimed is:

1. A multilayer film comprising:
a film base containing polyester; and
an adhesive layer provided on one of surfaces of the film base and having a thickness of at least 0.1 μm, the adhesive layer being used to attach the film base to an optical functional layer containing an organic material and containing at least 10 mass % of polyolefin.

2. The multilayer film of claim 1, wherein the adhesive layer has an elastic modulus of at most 500 MPa.

3. The multilayer film of claim 1, wherein the adhesive layer contains a cross-linking agent.

4. The multilayer film of claim 2, wherein the adhesive layer contains a cross-linking agent.

5. The multilayer film of claim 3, wherein the cross-linking agent is any one of an oxazoline compound, a carbodiimide compound, epoxy, isocyanate, and melamine.

6. The multilayer film of claim 4, wherein the cross-linking agent is any one of an oxazoline compound, a carbodiimide compound, epoxy, isocyanate, and melamine.

7. The multilayer film of claim 1, wherein the adhesive layer contains acrylic resin.

8. The multilayer film of claim 2, wherein the adhesive layer contains acrylic resin.

9. The multilayer film of claim 3, wherein the adhesive layer contains acrylic resin.

10. The multilayer film of claim 4, wherein the adhesive layer contains acrylic resin.

11. The multilayer film of claim 7, wherein a mass ratio of the acrylic resin to the polyolefin is in a range of not less than 5% to not more than 700%.

12. The multilayer film of claim 8, wherein a mass ratio of the acrylic resin to the polyolefin is in a range of not less than 5% to not more than 700%.

13. The multilayer film of claim 9, wherein a mass ratio of the acrylic resin to the polyolefin is in a range of not less than 5% to not more than 700%.

14. The multilayer film of claim 10, wherein a mass ratio of the acrylic resin to the polyolefin is in a range of not less than 5% to not more than 700%.

15. An optical sheet comprising:
an optical functional layer for deflecting incident light so as to collect or diffuse the incident light, the optical functional layer containing an organic material;
a film base containing polyester; and
an adhesive layer provided between the film base and the optical functional layer and having a thickness of at least 0.1 μm, the adhesive layer being used to attach the film base to the optical functional layer and containing at least 10 mass % of polyolefin.

16. The optical sheet of claim 15, wherein the adhesive layer has an elastic modulus of at most 500 MPa.

17. The optical sheet of claim 15, wherein the adhesive layer contains a cross-linking agent.

18. The optical sheet of claim 16, wherein the adhesive layer contains a cross-linking agent.

19. The optical sheet of claim 15, wherein the cross-linking agent is any one of an oxazoline compound, a carbodiimide compound, epoxy, isocyanate, and melamine.

20. The optical sheet of claim 16, wherein the cross-linking agent is any one of an oxazoline compound, a carbodiimide compound, epoxy, isocyanate, and melamine.
